(19) United States
(12) Patent Application Publication
(10) Pub. No.: US 2014/0316775 A1
(43) Pub. Date: Oct. 23, 2014

(54) NOISE SUPPRESSION DEVICE

(71) Applicant: Satoru Furuta, Tokyo (JP)

(72) Inventor: Satoru Furuta, Tokyo (JP)

(73) Assignee: Mitsubishi Electric Corporation, Tokyo (JP)

(21) Appl. No.: 14/364,179

(22) PCT Filed: Feb. 10, 2012
(86) PCT No.: PCT/JP2012/000914

§ 371 Date: Jun. 10, 2014

(51) Int. Cl. G10L 21/0208; G10L 25/84

(52) U.S. Cl. CPC G10L 21/0208; G10L 25/84
USPC 704/226

(57) ABSTRACT

A probability density function controller determines a probability density function dependent upon whether an input signal appears to be a sound or noise, i.e., a probability density function that is suited to a distribution state of a sound signal in a sound section and that in a noise section, and a suppression amount calculator 8 calculates a spectrum suppression amount by using the probability density function.

### FIELD OF THE INVENTION

The present invention relates to a noise suppression device that suppresses background noise piggybacked onto an input signal.

### BACKGROUND OF THE INVENTION

Voice calls made outdoors using mobile phones, hands free voice calls made in vehicles, and handsfree operations using voice recognition have spread widely as digital signal processing technology has progressed in recent years. Because a device that implements these functions is used under high noise environments in many cases, background noise may also be inputted to a microphone together with a sound, and this causes degradation in the call voice, reduction in the voice recognition rate, etc. Therefore, in order to implement a comfortable voice call and high-accuracy voice recognition, a noise suppression device that suppresses background noise mixed into an input signal is needed.

As a conventional noise suppression device, for example, there is a method of converting an input signal in time domain into a power spectrum which is a signal in frequency domain, using a power spectrum of the input signal and an estimated noise spectrum separately estimated from the input signal and assuming that the sound spectrum follows a super Gaussian distribution, and the noise spectrum follows a Gaussian distribution to calculate a suppression amount for noise suppression by using a MAP (a posteriori probability maximization) estimating method, performing amplitude suppression on the power spectrum of the input signal, by using the acquired suppression amount, and converting the power spectrum on which the amplitude suppression is performed and the phase spectrum of the input signal into a signal in time domain to acquire a noise-suppressed signal (for example, refer to nonpatent reference 1).

In addition, as a prior art, for example, patent reference 1 is disclosed. This conventional noise suppression device performs partial differential on an estimated equation of a sound spectrum included in a frequency spectrum, the equation being derived by approximating the probability of occurrence for each of the real and imaginary parts of the sound spectrum by using a statistical distribution model, and puts the results of the partial differential to be equal to zero, and calculates an amount of noise suppression according to a computing equation which is approximated by setting |cosφ|+|sinφ|,where the phase spectrum is expressed by φ, to be a constant, thereby implementing high-quality noise suppression.

Further, as another prior art, for example, there is a method of approximating the probability of occurrence of a sound spectrum and that of a noise spectrum by using a mixed distribution model which is a combination of a plurality of probability density functions so as to perform high-accuracy noise suppression (for example, refer to nonpatent reference 2).

### RELATED ART DOCUMENTS

### Patent Reference

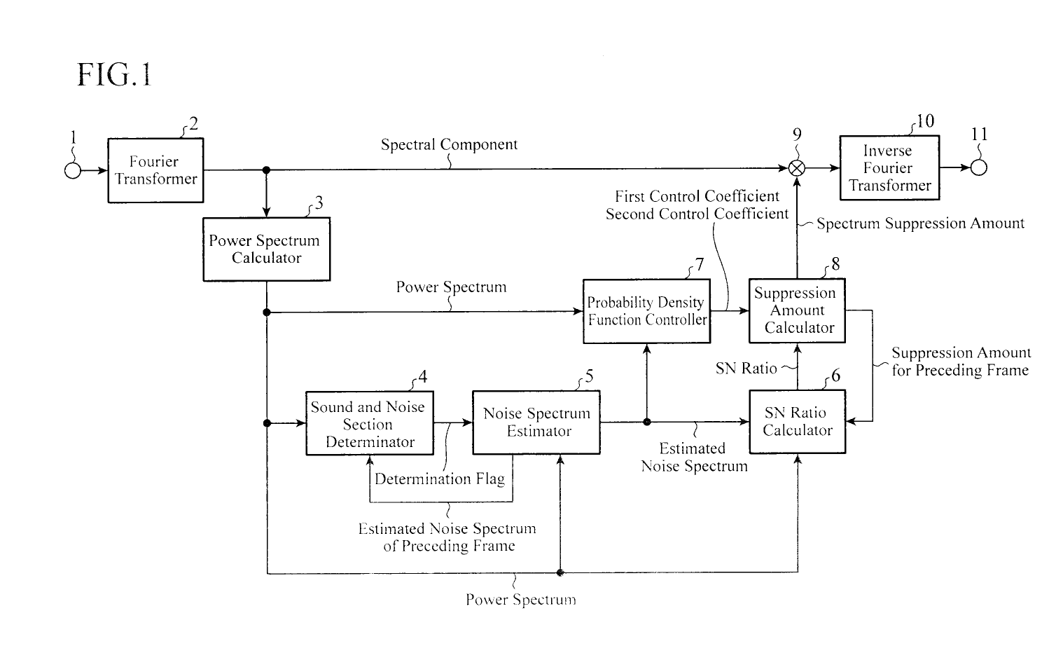

Patent reference 1: Japanese Unexamined Patent Application Publication No. 2005-202222 (pp. 6-11, FIG. 1)

### Nonpatent References

Nonpatent reference 1: T. Lotter, P. Vary, “Speech Enhancement by MAP Spectral Amplitude Estimation Using a Super-Gaussian Speech Model”, EURASIP Journal on Applied Signal Processing, pp.1110-1126, No. 7, 2005
Nonpatent reference 2: Fujimoto and Ariki, “Additive and Channel Noise Suppression Method Based on GMM and EM Algorithm”, the Institute of Electronics, Information and Communication Engineers Technical Report, SP2003-117, pp.25-30, December, 2003

### SUMMARY OF THE INVENTION

### Problems to be Solved by the Invention

The above-mentioned conventional methods have problems which will be mentioned below.

A problem with the conventional noise suppression device disclosed by above-mentioned nonpatent reference 1 is that because the number of parameters for determining the distribution shape of the probability density function is one, and the parameter is fixed regardless of the state of the input signal, the estimation accuracy of the amount of noise suppression is low for various input signals.

Further, because the conventional noise suppression device disclosed by above-mentioned patent reference 1 uses the phase spectrum of the input signal in order to determine the distribution shape of the probability density function, the conventional noise suppression device needs to analyze the phase spectrum of the sound signal with high accuracy in order to perform high-quality noise suppression. A further problem is that because the parameter defining the distribution shape (referred to as a setting A for approximation in the reference) is not changed according to the state of the input signal and is fixed, the estimation of the amount of noise suppression cannot be followed when an unexpected rapid variation, such as a variation exceeding the setting for approximation, occurs in the sound and noise which are the input signal.

Further, a problem with the conventional noise suppression device disclosed by above-mentioned nonpatent reference 2 is that while high-accuracy noise suppression can be performed by using a mixed distribution model which is a combination of a plurality of probability density functions, a huge amount of information processed is required.

The present invention is made in order to solve these problems, and it is therefore an object of the present invention to provide a noise suppression device that provides high-quality noise suppression by performing a simple process.

### Means for Solving the Problem

In accordance with the present invention, there is provided a noise suppression device including a probability density function controller that analyzes an input signal to calculate a first index showing whether the input signal appears to be a sound or noise, and that controls a probability density function that defines a distribution state of a sound on the basis of the above-mentioned first index, and calculates a suppression amount by using the probability density function in addition to a power spectrum and a noise estimated spectrum.

### ADVANTAGES OF THE INVENTION

According to the present invention, by calculating the suppression amount for noise suppression by using the probability density function controlled on the basis of the first index showing whether the input signal appears to be a sound or noise, high-quality noise suppression not providing any feeling that something is abnormal in a noise section and having a small distortion in the sound can be performed through the simple process.

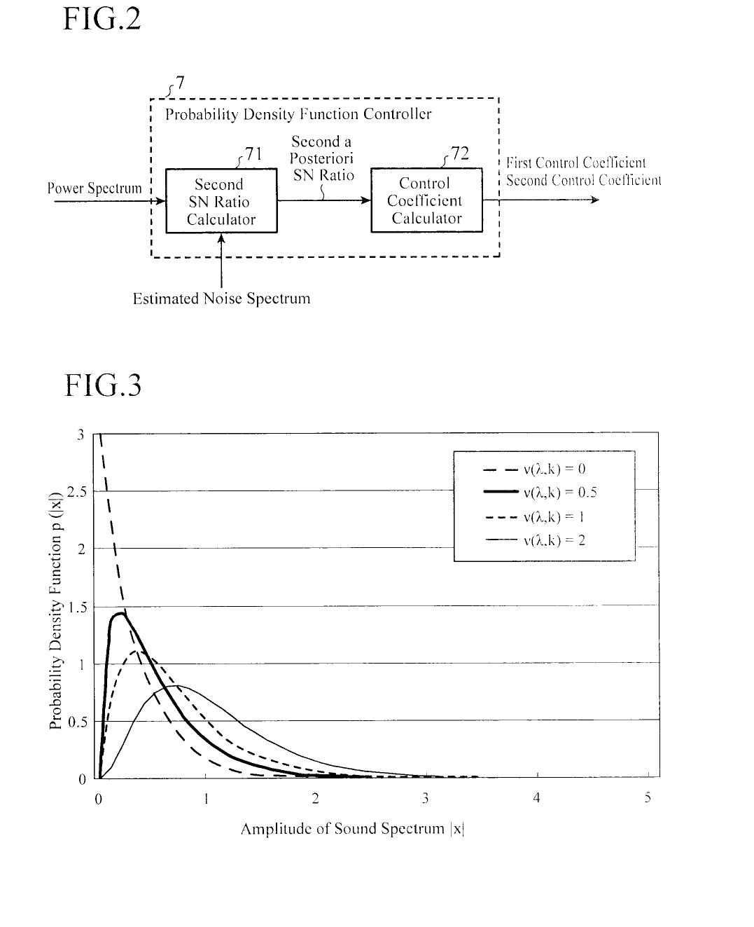

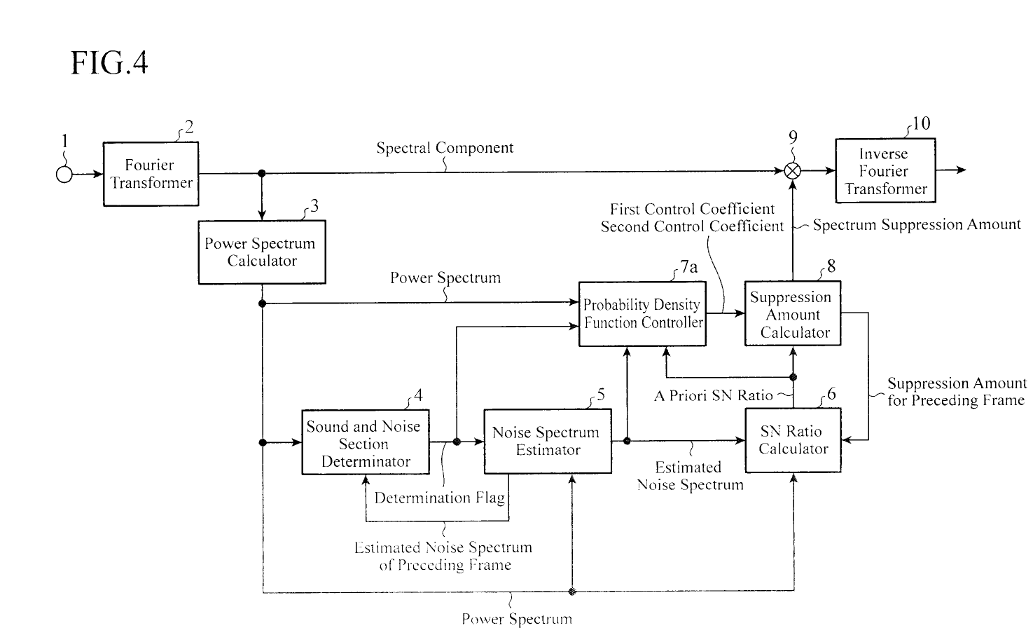

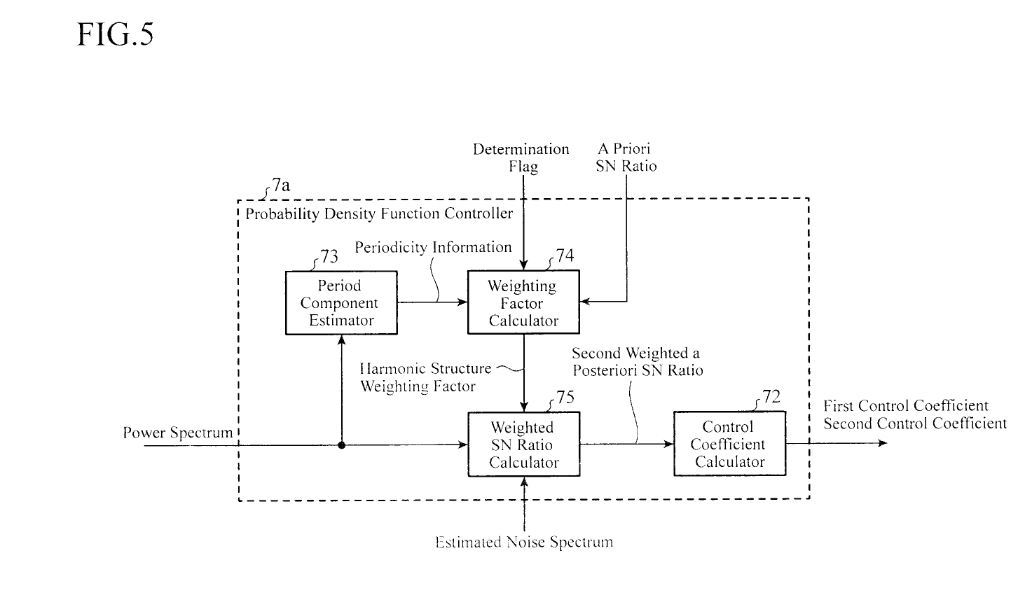

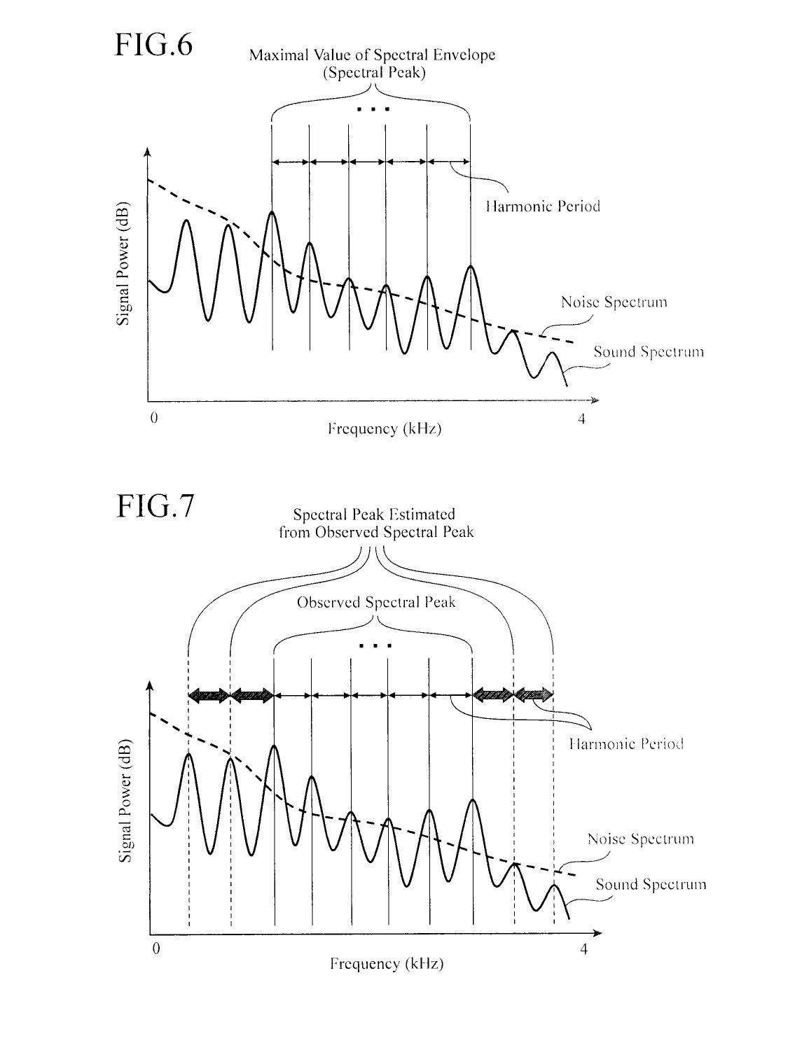

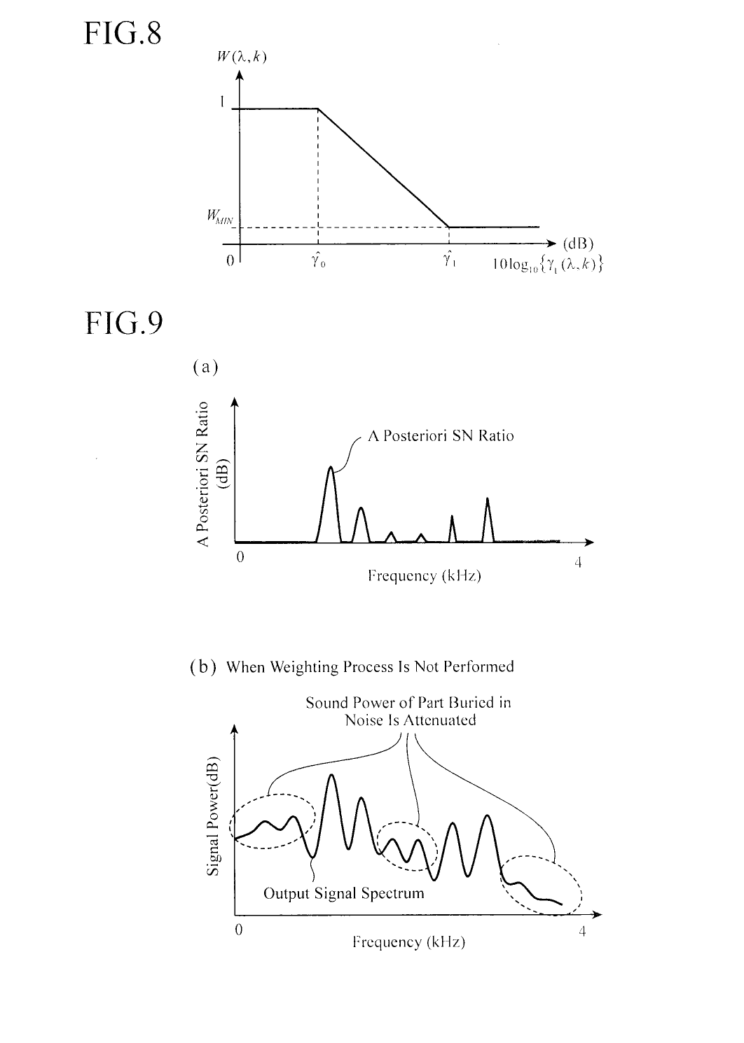

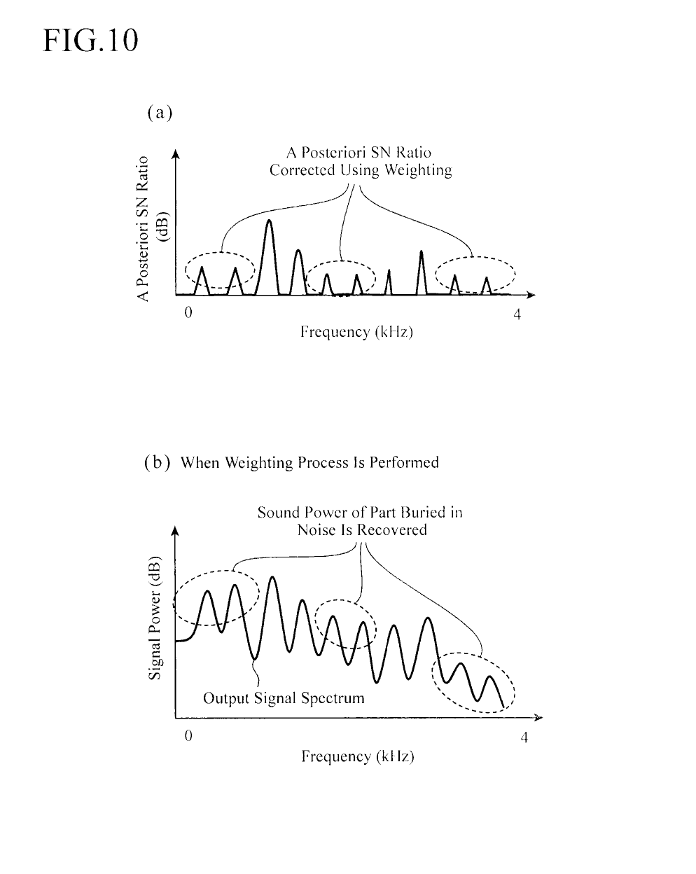

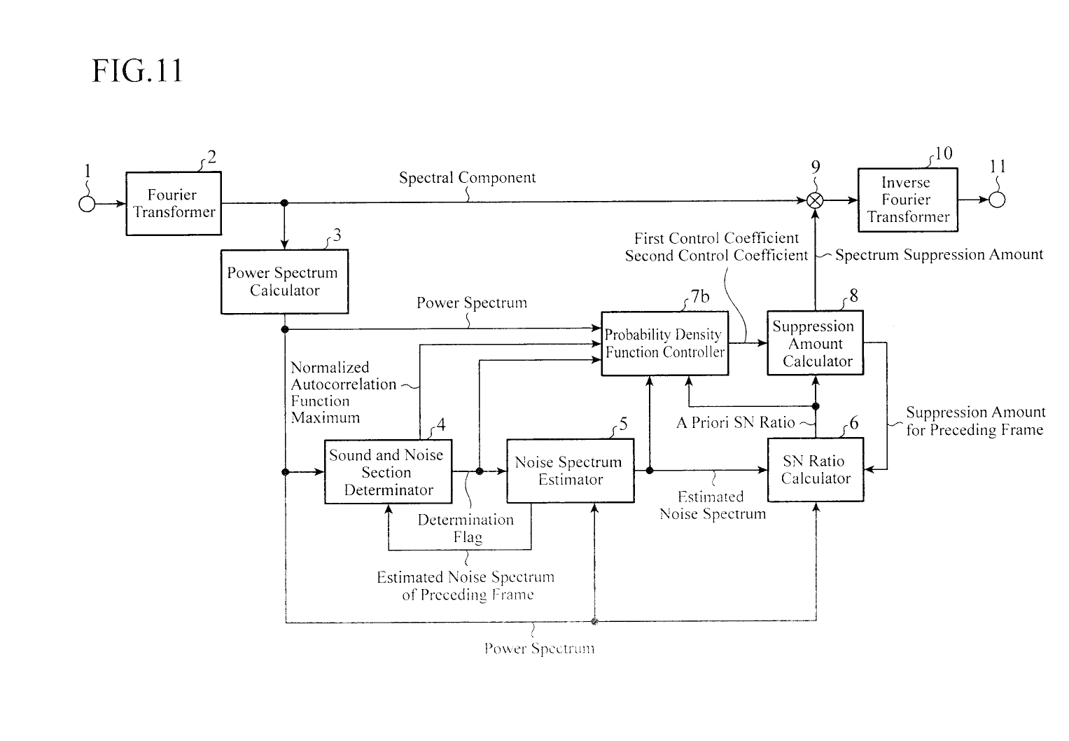

### BRIEF DESCRIPTION OF THE FIGURES

[FIG. 1] FIG. 1 is a block diagram showing the structure of a noise suppression device according to Embodiment 1 of the present invention;

[FIG. 2] FIG. 2 is a block diagram showing the internal, structure of a probability density function controller in Embodiment 1;

[FIG. 3] FIG. 3 is a graph explaining a change of a probability density function in Embodiment 1;

[FIG. 4] FIG. 4 is a block diagram showing the structure of a noise suppression device according to Embodiment 2 of the present invention;

[FIG. 5] FIG. 5 is a block diagram showing the internal structure of a probability density function controller in Embodiment 2;

[FIG. 6] FIG. 6 is a graph schematically showing a method of detecting the harmonic structure of a sound which a period component estimator uses in Embodiment 2;

[FIG. 7] FIG. 7 is a graph schematically showing a method of correcting the harmonic structure of a sound which the period component estimator uses in Embodiment 2;

[FIG. 8] FIG. 8 is a graph showing a nonlinear function which a weighted SN ratio calculator uses at the time of calculation of a first weighted a posteriori SN ratio in Embodiment 2;

[FIG. 9] FIG. 9 shows an example of an output result of the noise suppression device in accordance with Embodiment 2, and a case in which weighting of an a posteriori SN ratio is not performed;

[FIG. 10] FIG. 10 shows an example of the output result of the noise suppression device in accordance with Embodiment 2, and a case in which weighting of an a posteriori SN ratio is performed; and

[FIG. 11] FIG. 11 is a block diagram showing the structure of a noise suppression device according to Embodiment 4 of the present invention.

### EMBODIMENTS OF THE INVENTION

Hereafter, in order to explain this invention in greater detail, the preferred embodiments of the present invention will be described with reference to the accompanying drawings. Embodiment 1.

FIG. 1 is a block diagram showing the entire structure of a noise suppression device in accordance with this Embodiment 1. The noise suppression device in accordance with this Embodiment 1 is comprised of an input terminal 1, a Fourier transformer 2, a power spectrum calculator 3, a sound and noise section determinator 4, a noise spectrum estimator b, an SN ratio calculator 6, a probability density function controller 7, a suppression amount calculator 8, a spectrum suppressor 9, an inverse Fourier transformer 10, and an output terminal 11.

Hereafter, the principle of operation of this noise suppression device will be explained with reference to drawings.

First, after a sound, music, or the like which is captured via a microphone (not shown) or the like is A/D (analog-to-digital) converted, the sound, the music, or the like is sampled at a predetermined sampling frequency (e.g., a frequency of 8 kHz) and is also divided into frames (e.g., units of 10 ms), and these frames are inputted to the noise suppression device according to this Embodiment 1 via the input terminal 1.

After applying, for example, a Hanning window to the input signal, the Fourier transformer 2 performs a 256-point fast Fourier transform as shown in, for example, the following equation (1), and converts the signal in time domain x (t) info spectral components X (λ, k) each of which is a signal in frequency domain.

X(λ, k)=FT[x(t)] (1)

where t shows a sampling time, λ shows a frame number when the input signal is divided into frames, k shows a number (referred to as a spectrum number from here on) specifying a frequency component in the frequency band of the spectrum, and FT [•] shows the Fourier transform process.

The power spectrum calculator 3 acquires a power spectrum Y (λ, k) from the spectral component X (λ, k) of the input signal by using the following equation (2).

Y(λ, k)=\sqrt{Re {X (λ, k)}²+Im{X (λ, k)}²}; 0≦k≦128 (2)

where Re {X (λ, k)} and Im {X (λ, k)} show the real and imaginary parts of the input signal spectrum Fourier-transformed, respectively.

The sound and noise section determinator 4 determines whether the input signal of the current frame is a sound or noise. First, the sound and noise section determinator determines a normalized autocorrelation function o_{N}(λ, τ) from the power spectrum Y (λ, k) by using the following equation (3).

$$ρ ( λ , τ ) = FT [ Y ( λ , k ) ] , \\ {ρ}_{N} ( λ , τ ) = \frac{ρ ( λ , τ )}{ρ ( λ , 0 )} \qquad ( 3 )$$

where τ is a delay time, and FT[•] shows a Fourier transform process. For example, what is necessary is just to perform a fast Fourier transform with the same point number=256 as that shown in the above equation (1). Because the equation (3) is based on the Wiener-Khintchine theorem, the explanation of the equation will be omitted hereafter.

The sound and noise section determinator 4 then calculates a maximum ρₘₐₓ (λ) of the normalized autocorrelation function by using the following equation (4). The equation (4) means that the sound and noise section determinator searches for a maximum of ρ(λ, τ) in the range of 16≦τ≦96.

ρₘₐₓ(λ)=max[ρ(λ, τ)], 16≦τ≦96 (4)

Next, the sound and noise section determinator 4 receives the power spectrum Y (λ, k) outputted by the power spectrum calculator 3, the maximum ρₘₐₓ (λ) of the normalized autocorrelation function acquired in the above-mentioned process, and an estimated noise spectrum N (λ, k) outputted by the noise spectrum estimator 5 which will be mentioned below, and determines whether the input signal of the current frame is a sound or noise and outputs the result of the determination as a determination flag. As a method of determining a sound section or a noise section, for example, when a condition shown by the following equation (5) is satisfied, it is determined that the input signal is a sound and a determination flag Vflag is set to “1 (sound)”; otherwise, it is determined that the input signal is noise and the determination flag Vflag is set to “0 (noise)”, and the determination flag is then, outputted.

$$vflag = \{ \begin{matrix}1 , & if 20 \cdot {log}_{10} ( {S}_{pow} / {N}_{pow} ) > {TH}_{FR\_SN} or {ρ}_{max} ( λ ) > {TH}_{ACF} \\ 0 , & Otherwise\end{matrix} \\ where \\ {S}_{pow} = {\sum }_{k = 0}^{127} Y ( λ , k ) , \\ {N}_{pow} = {\sum }_{k = 0}^{127} N ( λ , k ) \qquad ( 5 )$$

In the equation (5), N(λ, k) is the estimated noise spectrum, and S_{pow} and N_{pow} show the sum total of the power spectra of the input signal and the sum total of the estimated noise spectra of the input signal, respectively. Further, TH_{FE}_{_{—}}_{SN} and TH_{ACF} show predetermined constant thresholds tor the determination. Although there is a case of TH_{FR}_{_{—}}_{SN}=3.0 and TH_{ACF}=0.3 as a suitable example, these thresholds can also be changed properly according to the state and noise level of the input signal. Although in this Embodiment 1 the autocorrelation function method and the average SN ratio of the input signal are used as the method of determining a sound section or a noise section, the method is not limited to this example. A known method, such as a cepstrum analysis, can be alternatively used. Further, a combination of some of various known methods according to the discretion of those skilled in the art makes it possible to improve the accuracy of the determination.

The noise spectrum estimator 5 receives the power spectrum Y (λ, k) outputted by the power spectrum calculator 3 and the determination flag Vflag outputted by the; sound and noise section determinator 4, performs an estimation and an update of a noise spectrum according to the following equation (6) and the determination flag Vflag, and outputs the estimated noise spectrum N (λ, k).

$$N ( λ , k ) = \{ \begin{matrix}( 1 - α ) \cdot N ( λ - 1 , k ) + α \cdot {\vert Y ( λ , k ) \vert}^{2} & if & Vflag = 0 \\ N ( λ - 1 , k ) & if & Vflag = 1\end{matrix} ; 0 \leq k < 128 \qquad ( 6 )$$

where N (λ−1, k) is the estimated noise spectrum of the preceding frame. This estimated noise spectrum is held in a storage (not shown) in the noise spectrum estimator 5, such as a RAM (Random Access Memory). α is an update coefficient and is a predetermined constant having a range of 0<α<1. Although the update coefficient α is 0.95 as a suitable example, the update coefficient can also be changed properly according to the state and noise level of the input signal.

Because the input signal of the current frame is determined to be noise when the determination flag Vflag=0 in the above equation (6), the estimated noise spectrum N (λ−1, k) of the preceding frame is updated by using the power spectrum Y (λ, k) of the input signal and the update coefficient α. in contrast, when the determination flag Vflag=1 , the input signal of the current frame is a sound and the estimated noise spectrum N (λ−1, k) of the preceding frame is outputted as the estimated noise spectrum N (λ, k) of the current frame, just as it is.

The SN ratio calculator 6 calculates an a posteriori SN ratio (a posteriori Signal to Noise Ratio) and an a priori St ratio (a priori Signal to Norse Ratio) for each spectral component by using the power spectrum Y (λ, k) outputted by the power spectrum calculator 3, the estimated noise spectrum N (λ, k) outputted by the noise spectrum estimator 5, and a spectrum suppression amount G (λ−1, k) of the preceding frame which is outputted by the suppression amount calculator 8 which will be mentioned below. The SN ratio calculator determines the a posteriori SN ratio γ(λ, k) by using the power spectrum Y (λ, k) and the estimated noise spectrum N (λ, k) according to the following equation (7). The SN ratio calculator also determines the a priori SN ratio ξ (λ, k) by using the spectrum suppression amount G (λ−1, k) of the preceding frame and the a posteriori SN ratio y(K, k) of the preceding frame according to the following equation (8).

$$\begin{matrix}γ ( λ , k ) = \frac{{\vert Y ( λ , k ) \vert}^{2}}{N ( λ , k )} & ( 7 ) \\ ξ ( λ , k ) = δ \cdot γ ( λ - 1 , k ) \cdot {G}^{2} ( λ - 1 , k ) + ( 1 - δ ) \cdot F [ γ ( λ , k ) - 1 ] \\ where \\ F [ x ] = \{ \begin{matrix}x , & x > 0 \\ 0 , & else\end{matrix} & ( 8 )\end{matrix}$$

where δ is a predetermined constant having a range of 0<δ<1, and δ=0.98 is preferable in this embodiment. Further, F[•] means half wave rectification, and, when the a posteriori SN ratio γ(λ, k) is negative in decibels, floors the a posteriori SN ratio at zero.

After that, the acquired a posteriori SN ratio γ(λ, k) and the acquired a priori SN ratio ξ (λ, k) are outputted from the SN ratio calculator 6 to the spectrum suppressor 9.

The probability density function controller 7 determines the shape (distribution state) of a probability density function dependent upon the state of the input signal of the current frame by using the power spectrum Y (λ, k) outputted by the power spectrum calculator 3 and the estimated noise spectrum N (λ, k) outputted by the noise spectrum estimator 5, and outputs a first control coefficient ν (λ, k) and a second control coefficient μ (λ, k) to the suppression amount calculator 8. A detailed operation of this probability density function controller 7 will be mentioned below.

The suppression amount calculator 8 receives the a priori SN ratio ξ (λ, k) and the a posteriori SN ratio γ(λ, k) which are outputted by the SN ratio calculator 6, and the first control coefficient ν (λ, k) and the second control coefficient μ (λ, k) which are outputted by the probability density function controller 7, calculates a spectrum suppression amount G (λ, k) which is an amount of noise suppression for each spectrum, and outputs this spectrum suppression amount to the spectrum suppressor 9.

As a method of calculating the spectrum suppression, amount G (λ, k), for example, a Joint MAP method can be applied. The Joint MAP method is the one of estimating the spectrum suppression amount G (λ, k) by assuming that a noise signal and a sound signal have a Gaussian distribution, determining an amplitude spectrum and a phase spectrum which maximize a conditional probability density function by using the a priori SN ratio ξ (λ, k) and the a posteriori SN ratio γ(λ, k), and using the value as an estimated value. The spectrum suppression amount G (λ, k) can be expressed by the following equations (9) and (10) with the first control coefficient ν (λ, k) and the second control coefficient μ (λ, k) which determine the shape of the probability density function being set as parameters. Refer to the nonpatent reference 1 as to the details of the method of deriving the spectrum suppression amount in the Joint MAP method. An explanation of the details of the method will be omitted hereafter.

$$\begin{matrix}G ( λ , k ) = u ( λ , k ) + \sqrt{{u}^{2} ( λ , k ) + \frac{v ( λ , k )}{2 γ ( λ , k )}} & ( 9 ) \\ u ( λ , k ) = \frac{1}{2} - \frac{μ ( λ , k )}{4 \sqrt{γ ( λ , k ) ξ ( λ , k )}} & ( 10 )\end{matrix}$$

The spectrum suppressor 9 performs suppression by the spectrum suppression amount G (λ, k) for each spectrum of the input signal according to the following equation (11), determines a sound signal spectrum S (λ, k) on which the noise suppression is performed, and outputs this sound signal spectrum to the inverse Fourier transformer 10.

S(λ, k)=G(λ, k)·Y(λ, k) (11)

Then, after an inverse Fourier transform is performed on the acquired sound spectrum S (λ, k) by the inverse Fourier transformer 10, and the result is superimposed on the output signal of the preceding frame, a sound signal s(t) on which the noise suppression is performed is outputted from the output terminal 11.

Next, the operation of the probability density function controller 7 which is a main part of the present invention will be explained. The internal structure of the probability density function controller 7 is shown in FIG. 2. This probability density function controller 7 determines the shape of a probability density function dependent upon the state of the input signal by using the power spectrum Y (λ, k) outputted by the power spectrum calculator 3 and the estimated noise spectrum N (λ, k) outputted by the noise spectrum estimator b, and also outputs the first control coefficient ν (λ, k) and the second control coefficient μ (λ, k) required for the suppression amount calculator 8 to calculate the spectrum suppression amount G (λ, k).

First, in order to explain descriptions of this process, the probability density function p (|X|) of the amplitude |X| of the sound spectrum acquired using the Joint MAP method, the probability density function defining the above-mentioned equations (9) and (10), is shown in equation (12).

$$p ( \vert X \vert ) = \frac{{μ}^{v + 1}}{Γ ( v + 1 )} \frac{{\vert X \vert}^{v}}{{σ}_{x}^{v + 1}} exp ( - μ \frac{\vert X \vert}{{σ}_{x}} ) \qquad ( 12 )$$

where Γ(•) is a gamma function and σₓ is the variance of the sound spectrum. Further, μ and ν are constant, coefficients which determine the steepness of the distribution of the probability density function, and the broadening of the distribution, respectively, and the shape of the probability density function can be controlled by changing theses two coefficients. Therefore, a probability density function dependent upon the state of the input signal can be acquired by changing μ and ν according to the state of the input signal. In order to control the probability density function according to the state of the input signal, for example, the a posteriori SN ratio γ (λ, k) given by the above-mentioned equation (7) can be used.

The second SN ratio calculator 71 calculates the logarithm by using the power spectrum Y (λ, k) and the estimated noise spectrum N (λ, k), and calculates a second a posteriori SN ratio γₚ (λ, k) which is expressed in decibels, as shown in the following equation (13).

$${γ}_{P} ( λ , k ) = 10 {log}_{10} ( \frac{{\vert Y ( λ , k ) \vert}^{2}}{N ( λ , k )} ) \qquad ( 13 )$$

The control coefficient calculator 72 calculates the first control coefficient ν (λ, k) and the second control coefficient μ (λ, k), as shown in the following equations (14) to (16), by using the second a posteriori SN ratio γₚ (λ, k) acquired by the second SN ratio calculator 71, and outputs each of the control coefficients to the suppression amount calculator 8.

$$\begin{matrix}v ( λ , k ) = \{ \begin{matrix}{v}_{MAX} , & \hat{v} ( λ , k ) \geq {v}_{MAX} \\ \hat{v} ( λ , k ) , & {v}_{MIN} < v ( λ , k ) < {\hat{v}}_{MAX} \\ {v}_{MIN} , & \hat{v} ( λ , k ) \leq {v}_{MIN}\end{matrix} , 0 \leq k < 128 & ( 14 ) \\ μ ( λ , k ) = \{ \begin{matrix}{μ}_{MAX} , & \hat{μ} ( λ , k ) \geq {μ}_{MAX} \\ \hat{μ} ( λ , k ) , & {μ}_{MIN} < μ ( λ , k ) < {\hat{μ}}_{MAX} , \\ {μ}_{MIN} , & \hat{μ} ( λ , k ) \leq {μ}_{MIN}\end{matrix} 0 \leq k < 128 \\ where & ( 15 ) \\ \hat{v} ( λ , k ) = {K}_{v} ( k ) \cdot {γ}_{P} ( λ , k ) , \\ \hat{μ} ( λ , k ) = {K}_{μ} ( k ) \cdot {γ}_{P} ( λ , k ) \\ {K}_{v} ( k ) = ( 1 + 0.2 \cdot k / 128 ) \cdot {C}_{v} , \\ {K}_{μ} ( k ) = ( 1 + 0.2 \cdot k / 128 ) \cdot {C}_{μ} , & ( 16 )\end{matrix}$$

In the above equations, ν_{MAX} and ν_{MIN} are predetermined constants for determining an upper limit and a lower limit on the first control coefficient ν (λ, k), respectively, and μ_{MAX} and μ_{MIN} are predetermined constants for determining an upper limit and a lower limit on the second control coefficient μ (λ, k), respectively. Although there is a case of ν_{MAX}=2.0, ν_{MIN}=0.0, μ_{MAX}=10.0, and μ_{MIN}=1.0 as a suitable example in this embodiment, these values can be changed properly according to the state of a sound and that of noise in the input signal. Further, K_{ν} (k) and K_{μ} (k) in the above equation (16) are functions that associate the second a posteriori SN ratio with the control coefficients, and the noise suppression device operates in such a way as to change the first control coefficient ν (λ, k) or the second control coefficient μ (λ, k) more greatly with respect to the value of the second a posteriori SN ratio γₚ (λ, k) as the frequency increases. By performing this way, for example, there is provided an advantage of preventing a sound having a small amplitude, such as a consonant having a high frequency, from being erroneously assumed to be noise and suppressed. Further, C_{ν} and C_{μ} are predetermined constants acquired experimentally. Although there is a case of C_{ν}=0.1 and C_{μ}=−10 as a suitable example in this embodiment, these values can also be changed properly according to the state of a sound and that of noise in the input signal.

According to the above-mentioned equations (14) to (16), as the second a posteriori SN ratio γₚ (λ, k) increases, the first control coefficient ν (λ, k) increases. More specifically, while the degree of variance increases, the second control coefficient μ (λ, k) decreases and the sharpness of the distribution decreases. As a result, the shape of the distribution of the probability density function p (|X|) has a gentle inclination, and approximates to the distribution state of the sound signal in the sound section. In contrast, as the second a posteriori SN ratio γₚ (λ, k) decreases, while the first control coefficient ν (λ, k) decreases and the degree of variance decreases, the second control coefficient μ (λ, k) increases and the sharpness of the distribution increases. As a result, the shape of the distribution of the probability density function p (|X|) has a steep inclination, and approximates to the distribution state of the sound signal in the noise section (a state in which no sound exists or a sound having a small amplitude exists).

FIG. 3 shows an example of the distribution state of the probability density function p (|X|) when the second control coefficient μ (λ, k) is fixed and the first control coefficient ν (λ, k) is changed. In FIG. 3, the horizontal axis shows the amplitude |X| of the sound spectrum, and the vertical axis shows the value of the probability density function p (|X|). It can be seen from FIG. 3 that as the first control coefficient ν (λ, k) decreases, the shape of the probability density function p(|X|) becomes narrow and sharp and changes from the distribution state of the sound signal to the distribution state of the sound signal at a time when a noise signal is mixed. By applying the first control coefficient ν (λ, k) and the second control coefficient μ (λ, k) acquired as above to the above equations (12) and (13), a high-accuracy spectrum suppression amount G (λ, k) dependent upon the state of the input signal can be calculated, and high-quality noise suppression can be implemented.

As mentioned above, the noise suppression device according to this Embodiment 1 includes the input terminal 1 that receives an input signal, the Fourier transformer 2 that converts the input signal in time domain into a signal in frequency domain, the power spectrum calculator 3 that calculates a power spectrum from the signal in frequency domain, the sound and noise section determinator 4 that determines a sound section or a noise section on the basis of the power spectrum of the input signal, the noise spectrum estimator b that estimates an estimated noise spectrum from the power spectrum and the result of the determination, the SN ratio calculator 6 that calculates an SN ratio from the power spectrum and the estimated noise spectrum, the probability density function controller 7 that controls a probability density function defining the distribution state of a sound on the basis of a first index showing whether the input signal appears to be a sound or noise, the suppression amount calculator 8 that, calculates a suppression amount for noise suppression from the SN ratio and the probability density function, the spectrum suppressor 9 that performs amplitude suppression on the power spectrum according to the suppression amount, the inverse Fourier transformer 10 that converts the power spectrum on which the amplitude suppression is performed into a signal in time domain to acquire a noise-suppressed signal, and the output, terminal 11 that outputs the noise-suppressed signal, and the probability density function controller 7 is constructed in such a way as to include the second SN ratio calculator 71 that estimates an SN ratio (second a posteriori SN ratio) for each frequency of the input signal, and the control coefficient calculator 72 that uses, as the first index, the SN ratio estimated by the second SN ratio calculator 71 to control the probability density function. Therefore, because the probability density function dependent upon the state of the input signal, i.e., the probability density function which is suited to the distribution state of the sound signal, in the sound section and that in the noise section can be applied at the time of calculating the spectrum suppression amount, high-quality noise suppression which does not provide a feeling of unusual sound in the noise section and which provides a Low distortion in the sound can be performed through the simple process.

Although in Embodiment 1 the control dependent upon the state of the input signal is performed on both the first control coefficient ν (λ, k) and the second control coefficient μ (λ, k), the control can be alternatively performed on at least one of the control coefficients. The same advantage is provided ever: when the control is performed singly on one of them. Embodiment 2.

Although in above-mentioned Embodiment 1 the control of the probability density function dependent upon the state of the input signal is performed by using the a posteriori SN ratio, weighting can be performed on this a posteriori SN ratio, for example. This example is aimed at, when the SN ratio is low even though a sound exists, such as when a sound signal is buried in noise, preventing the sound signal buried in noise from being suppressed erroneously by performing a weighting correct ion on a frequency band in which there is a high possibility that a sound exists in such a way that the a posteriori SN ratio increases.

FIG. 4 is a block diagram showing the entire structure of a noise suppression device in accordance with this Embodiment 2, and FIG. 5 is a block diagram showing the internal structure of a probability density function controller 7a in the noise suppression device. The probability density function controller 7a shown in FIG. 4 uses a power spectrum Y (λ, k) from a power spectrum calculator 3, a determination flag Vflag from a sound and noise section determinator 4, an estimated noise spectrum N (λ, k) from a noise spectrum estimator 5, and an a priori SN ratio ξ (λ, k) from an SN ratio calculator 6 as an input. The other structural components are the same as those shown in FIG. 1. In the probability density function controller 7a shown in FIG. 5, a period component estimator 73, a weighting factor calculator 74, and a weighted SN ratio calculator 75 are disposed as structural components different from those of the probability density function controller 7 shown in FIG. 2. The other structural components are the same as those shown in FIG. 2.

The period component estimator 73 receives the power spectrum Y(λ, k) outputted by the power spectrum calculator 3 and analyzes the harmonic structure of the input signal spectrum. As shown in FIG. 6, the period component estimator performs an analysis of the harmonic structure by detecting peaks of the harmonic structure which the power spectrum constructs (referred to as spectral peaks from here on). Concretely, in order to remove minute peak components which are unrelated to the harmonic structure, for example, about 20% of the maximum of the power spectrum is subtracted from each power spectrum, component, and, after that, maximal values of the spectral envelope of the power spectrum are tracked and obtained in order of increasing frequency. Although for the sake of simplicity the example of the power spectrum of FIG. 6 is described by assuming that the sound spectrum and the noise spectrum are different components, a noise spectrum is superimposed or (added to) a sound spectrum in an actual input signal, and a peak of the sound spectrum having power smaller than that of the noise spectrum cannot be observed. After searching for spectral peaks, when a found point is a maximal value of the power spectrum (a spectral peak), the period component, estimator 73 sets periodicity information p (λ, k) to 1; otherwise, sets the periodicity information p (λ, k) to zero, so that the period component estimator sets the value for each spectrum number k. Although all spectral peaks are extracted in the example shown in FIG. 6, the extraction can be alternatively performed only on a specific frequency band, such as a band having a good SN ratio.

The period component estimator 73 then estimates a peak of the sound spectrum buried in the noise spectrum on the basis of the harmonic periods of the observed spectral peaks. Concretely, the period component estimator assumes that spectral peaks exist at the harmonic periods (peak intervals) of the observed spectral peaks in sections in which no spectral peak is observed (a low frequency portion and a high frequency portion which are buried in noise), as shown in, for example, FIG. 7, and sets the periodicity information p (λ, k)=1for their spectrum numbers. Because there is a rare case in which a sound component exists in a very low frequency band (e.g., 17.0 Hz or less), the period component estimator does not have to set the periodicity information p (λ, k) to “1” for the band. The period component estimator can perform the same process also for a very high frequency band. By performing the above-mentioned process, the noise suppression device outputs the periodicity information p (λ, k) from the period component estimator 73 to the weighting factor calculator 74.

The weighting factor calculator 74 receives the periodicity information p (λ, k) outputted by the period component estimator 73, the determination flag Vflag outputted by the noise spectrum estimator 5, and the a priori SN ratio ξ (λ, k) outputted by the SN ratio calculator 6, and calculates a harmonic structure weighting factor Wₕ (λ, k) used for performing weighting for each spectral component for an a posteriori SN ratio calculated by the weighted SN ratio calculator 75 which will be mentioned below.

$${W}_{h} ( λ , k ) = \{ \begin{matrix}( 1 - β ) \cdot {W}_{h} ( λ - 1 , k ) + β \cdot {w}_{P} ( k ) & if & p ( λ , k ) = 1 \\ ( 1 - β ) \cdot {W}_{h} ( λ - 1 , k ) + β \cdot {w}_{Z} ( k ) & if & p ( λ , k ) = 0\end{matrix} ; 0 \leq k < 128$$

where Wₕ (λ−1, k) is the harmonic structure weighting factor of a preceding frame, and β is a predetermined constant for smoothing. For example, β=0.8 is preferable. Further, wₚ (k) is a weighting constant when the periodicity information p (λ, k)=1. For example, the weighting constant is determined from the determination flag Vflag and the a priori SN ratio ξ (λ, k), as shown in the following equation (18), and is smoothed by using the value at this spectrum number and the value at an adjacent spectrum number. By smoothing the weighting constant with the adjacent spectral component, there is provided an advantage of preventing the weighting factor from steepening, and absorbing errors occurring in the spectral peak analysis. Although the weighting constant w_{z} (k) at the time of the periodicity information p (λ, k)=0 can be usually kept to be 1.0, that is, the process at this time can be performed without weighting, the weighting constant can be alternatively controlled by using the determination flag Vflag and the a priori SN ratio ξ (λ, k) as needed, like in the case of using wₚ (k) given by the following equation (18).

$${w}_{P} ( k ) = \{ \begin{matrix}0.25 \cdot {\hat{w}}_{P} ( k - 1 ) + 1.25 \cdot {\hat{w}}_{P} ( k ) + 0.25 \cdot {\hat{w}}_{P} ( k + 1 ) , & 1 \leq k < 127 \\ {\hat{w}}_{P} ( k ) , & k = 0 , 127\end{matrix} \qquad ( 18 )$$

When the periodicity information p (λ, k)=1 and the determination flag Vflag=1 (sound),

$${\hat{w}}_{P} ( k ) = \{ \begin{matrix}1.0 & if ξ ( λ , k ) \geq {TH}_{SB\_SNR} \\ 4.0 & Otherwise\end{matrix} ; 0 \leq k < 128$$

When the periodicity information p (λ, k)−1 and the determination flag Vflag=0 (noise),

$${\hat{w}}_{P} ( k ) = \{ \begin{matrix}1.5 & if ξ ( λ , k ) \geq {TH}_{SB\_SNR} \\ 1.0 & Otherwise\end{matrix} ; 0 \leq k < 128$$

In the above equation, TH_{SB}_{_{—}}_{SNR} shows a predetermined constant threshold. By controlling the weighting constant. wₚ (k) by using the determination flag and the a priori SN ratio, as shown in the above equation (18), when the input signal is determined to be a sound by the sound and noise section determinator 4, large weighting can be performed on a spectral peak in a band in which a sound is buried in noise (a peak of the harmonic structure of the spectrum), while excessive weighting can be prevented from being performed on a spectral component in a band in which the SN ratio is high from the beginning. In contrast, when the input signal is determined to be noise by the sound and noise section determinator 4, by preventing the weighting from being performed (setting the weighting constant wₚ (k) to 1.0), and also performing the weighting on a spectral component which is estimated to have a high SN ratio, the weighting can be performed also in a case in which, for example, the determination flag is set erroneously to be noise even though the current frame is a sound. The threshold TH_{SB}_{_{—SNR}} can also be changed properly according to the state and noise level of the input signal.

The weighted SN ratio calculator 75 determines a weighted a posteriori SN ratio required for the control coefficient calculator 72 to calculate a first control coefficient ν (λ, k) and a second control coefficient μ (λ, k). First, the weighted SN ratio calculator determines a temporary a posteriori SN ratio γₜ (λ, k) from the power spectrum Y (λ, k) and the estimated noise spectrum N (λ, k) of the input signal by using the following equation (19).

$${γ}_{t} ( λ , k ) = \frac{{\vert Y ( λ , k ) \vert}^{2}}{N ( λ , k )} \qquad ( 19 )$$

Next, the weighted SN ratio calculator 75 refers to a nonlinear function shown in FIG. 8 to calculate a weighting factor W (λ, k) corresponding to the temporary a posteriori SN ratio γₜ (λ, k). As shown in FIG. 8, the weighting factor W (λ, k) takes on a function that provides a weight increasing with decrease in the temporary a posteriori SN ratio γₜ (λ, k) while providing a fixed weight when the temporary a posteriori SN ratio γₜ (λ, k) is large (or small) to a certain extent. Further, W_{MIN} shown in FIG. 8 is a predetermined constant for determining a lower limit on the weighting factor W (λ, k), and γ₀ hat and γ₁ hat (“̂” on the Greek letter is expressed by “hat” because this application is an electronic one) are predetermined constants. Although there is a case of W_{MIN}=0.25, γ₀ hat=3 (dB), and γ₁ hat=12 (dB) as a suitable example in this embodiment, these values can be changed properly according to the state of a sound and that of noise in the input signal. After that, the weighted SN ratio calculator performs weighting on the estimated noise spectrum N (λ, k) by using the acquired weighting factor W (λ, k) to calculate a first weighted a posteriori SN ratio γ_{w1} (λ, k), as shown in the following equation (20).

$${γ}_{w 1} ( λ , k ) = \frac{{\vert Y ( λ , k ) \vert}^{2}}{W ( λ , k ) \cdot N ( λ , k )} \qquad ( 20 )$$

Because by performing the weighting process shown by the above equation (20), the noise suppression device can control the probability density function after performing the correction in such a way as to estimate the a posteriori SN ratio in a band in which the SN ratio is low to be a higher value, the noise suppression device can prevent the sound from being excessively suppressed and can perform high-quality noise suppression.

Next, the weighted SN ratio calculator 75 uses the harmonic structure weighting factor Wₕ (λ, k) to perform a correction on a band in which there is a high possibility that a high-frequency component of a sound exists in such a way as to estimate the first weighted a posteriori SN ratio γ_{w1} (λ, k) acquired by using the above equation (20) to be a high value and calculate a second weighted a posteriori SN ratio γ_{w2} (λ, k), as shown in the following equation (21).

γ_{w2}(λ, k)=Wₕ(λ, k)·γ_{w1}(λ, k) (21)

Because by performing the weighting process shown by the above equation (21), the noise suppression device can control the probability density function after performing the correction in such a way as to estimate the a posteriori SN ratio in a band in which there is a high possibility that a high-frequency component of a sound exists to be a higher value, the noise suppression device can prevent the sound from being excessively suppressed and can perform high-quality noise suppression.

After that, the noise suppression device outputs the acquired second weighted a posteriori SN ratio γ_{w2} (λ, k) from the weighted SN ratio calculator 75 to the control coefficient-calculator 72.

FIGS. 9 and 10 are graphs each schematically showing a spectrum of an output signal in a sound section and a corresponding a posteriori SN ratio as an example of the output of the noise suppression device in accordance with this Embodiment 2. FIG. 9(a) shows the a posteriori SN ratio on which no weighting is performed when the spectrum shown in FIG. 6 is provided as the input signal, and the spectrum of the output signal which is the noise suppression processed result in that case is shown in FIG. 9(b). On the other hand, FIG. 10(a) shows the a posteriori SN ratio on which weighting shown by the above equations (20) and (21) is performed, and the spectrum of the output signal which is the noise suppression processed result in that case is shown in FIG. 10(b). In FIGS. 9(a) and 10(a), the a posteriori SN ratio is expressed in decibels, and, when the decibel value of the a posteriori SN ratio is negative, the display of the value is omitted and the value is floored at zero.

Referring to FIGS. 9(a) and 9(b), the power of a sound buried in noise or lying within a band in which the SN ratio is low is reduced. In contrast, referring to FIGS. 10(a) and 10(b), because the correction is performed in such a way that the a posteriori SN ratio of a sound buried in noise or lying within a band in which the SN ratio is low is estimated to be a high value, it can be seen that the sound power of the band is recovered and further enhanced noise suppression can be implemented.

As mentioned above, according to this Embodiment 2, the probability density function controller 7a of the noise suppression device estimates an SN ratio (temporary a posteriori SN ratio) for each frequency of the input signal, and includes the weighted SN ratio calculator 75 that performs weighting on the above-mentioned SN ratio estimated for each frequency on the basis of a second index showing whether the input signal appears to be a sound or noise, and the control coefficient calculator 72 is constructed in such a way as to control the probability density function by using the weighted SN ratio (second weighted a posteriori SN ratio) calculated by the weighted SN ratio calculator 75 as a first index. Therefore, the noise suppression device can prevent the sound from being excessively suppressed and can perform high-quality noise suppression.

Although in this Embodiment 2 the weighted SN ratio calculator 75 is constructed in such a way as to estimate an SN ratio for each frequency of the input signal and perform weighting on this SN ratio, Embodiment 2 is not limited to this example. The function of estimating the SN ratio can be separated from the weighted SN ratio calculator 75, and an SN ratio calculator corresponding to the second SN ratio calculator 71 according to above-mentioned Embodiment 1 can be constructed separately. In this structure, the weighted SN ratio calculator 75 performs weighting on the SN ratio estimated for each frequency on the basis of the second index showing whether the input signal appears to be a sound or noise.

Further, according to Embodiment 2 of the present invention, because the noise suppression device uses, as the second index, the temporary a posteriori SN ratio which the weighted SN ratio calculator 75 calculates by using the power spectrum and the estimated noise spectrum of the input signal to control the probability density function after correcting the a posteriori SN ratio in such a way as to hold a sound also in a band in which the sound is buried in noise and the SN ratio is negative, the noise suppression device can prevent the sound from being excessively suppressed and can perform high-quality noise suppression.

Further, according to this Embodiment 2, because the noise suppression device uses, as the second index, the a priori SN ratio which the SN ratio calculator 6 calculates by using the power spectrum and the estimated noise spectrum of the input signal, and the result of the determination of a sound section or a noise section, which the sound and noise section determinator 4 performs on the basis of the power spectrum of the input signal, to perform weighting control on the a posteriori SN ratio, there is provided an advantage of being able to prevent unnecessary weighting from being performed on a noise section and a band in which the SN ratio is high, thereby being able to perform higher-quality noise suppression.

Further, according to this Embodiment 2, the probability density function controller 7a includes the period component estimator 73 that analyzes the harmonic structure of the sound in the input signal, and the weighted SN ratio calculator 75 is constructed in such a way as to use the result of the analysis by the period component estimator 73 as the second index to perform weighting in such a way that the SN ratio of a peak of the power spectrum of the input signal is increased. Therefore, the noise suppression device can correct the a posterior SN ratio also in a band in which a sound is buried in noise In such a way as to hold the sound, thereby being able to perform higher-quality noise suppression.

Although in this Embodiment 2 the noise suppression device corrects the a posteriori SN ratios in all the bands, Embodiment 2 is not limited to this example. The noise suppression device can alternatively perform the correction only on a low-frequency region or a high-frequency region as needed, or only on a specific frequency band, such as a frequency band close to a frequency band of from 500 to 800 Hz. The correction on such a frequency band is effective for, for example, correction of a sound buried in narrow-band noise, such as wind noise or an automobile engine sound.

Further, although both the weighting process, as shown in the equation (20), for a band in which the SN ratio is low, and the weighting process, as shown in the equation (21), based on the harmonic structure of a sound are performed in this Embodiment 2, Embodiment 2 is not limited to this example. Only either one of the weighting processes can be performed, and either one of the advantages which are described in the weighting processes respectively can be provided.

### Embodiment 3

Although the values of weighting (the weighting constants wₚ (k) and w_{z} (k)) in the equation (18) shown in above-mentioned Embodiment 3 are fixed with respect to the frequency direction, the values can be alternatively different according to the frequency. For example, the weighting factor calculator 74 can increase the weighting for lower-frequency components because the lower-frequency components have a clear harmonic structure as typical sound characteristics (there is a large difference between peaks and valleys in the spectrum), and decrease the weighting as the frequency increases.

According to this Embodiment 3, because the weighting factor calculator 74 is constructed in such a way as to control the intensity of the weighting by the weighted SN ratio calculator 75 according to the frequency, the weighting factor calculator can perform weighting suitable for the frequency characteristics of a sound, and can perform higher-quality noise suppression.

### Embodiment 4

Further, although the values of weighting (the weighting constants wₚ (k) and w_{z} (k)) are set to be predetermined constants in the equation (18) shown in above-mentioned Embodiment 2, switching among a plurality of weighting constants can be alternatively performed according to an index showing the sound likeness of the input signal to use one of the weighting constants, or the values of weighting can be alternatively controlled by using a predetermined function. FIG. 11 is a block diagram showing the entire structure of a noise suppression device in accordance with this Embodiment 4. A probability density function controller 7b shown in FIG. 11 uses a power spectrum Y (λ, k) from a power spectrum calculator 3, a determination flag Vflag and a maximum ρₘₐₓ (λ) of a normalized autocorrelation function from a sound and noise section determinator 4, an estimated noise spectrum N (λ, k) from a noise spectrum estimator 5, and an a priori SN ratio ξ (λ, k) from an SN ratio calculator 6 as an input. The other structural components are the same as those shown in FIG. 4. Further, the probability density function controller 7b has the same internal structure as that shown in FIG. 5.

The noise suppression device in accordance with this Embodiment 4 inputs, for example, the maximum ρₘₐₓ (λ) of the normalized autocorrelation function outputted by the sound and noise section determinator 4 to a weighting factor calculator 74 (shown in FIG. 5) of the probability density function controller 7b as the index showing the sound likeness of the input signal, i.e., a control factor for the state of the input signal. When the maximum ρₘₐₓ (λ) of the normalized autocorrelation function in the above equation (4) is high, i.e., when the input signal has a clear periodical structure (there is a high possibility that the input signal is a sound), this weighting factor calculator 74 can increase the weights; otherwise, the weighting factor calculator can decrease the weights. Further, the weighting factor calculator can use the maximum ρₘₐₓ (λ) of the normalized autocorrelation function and the determination flag Vflag for determination of a sound section or a noise section together. In addition, this embodiment can be combined with above-mentioned Embodiment 3.

As mentioned above, according to this Embodiment 4, because the weighting factor calculator 74 is constructed in such a way as to control the intensity of the weighting by the weighted SN ratio calculator 75 according to the state of the input signal, the noise suppression device can perform the weighting in such a way as to make the periodic structure of a sound conspicuous when there is a high possibility that the input signal is a sound, thereby being able to reduce the degradation in the sound and perform higher-quality noise suppression.

### Embodiment 5

Because a noise suppression device according to this Embodiment 5 has the same structure as the noise suppression device, as shown in FIGS. 4 and 5, according to above-mentioned Embodiment 2 from a graphical viewpoint, the noise suppression device according to this embodiment will be explained by using FIGS. 4 and 5. As explained with reference to FIG. 6 in above-mentioned Embodiment 2, all the spectral peaks are detected for the estimation of period components. As an alternative, for example, the a priori SN ratio ξ (λ, k) outputted by the SN ratio calculator 6 can be inputted to the period component estimator 73, and the detection of spectral peaks only in a band in which the SN ratio is higher than a predetermined threshold can be performed by using the a priori SN ratio ξ (λ, k). Similarly, also in the calculation of the normalized autocorrelation function ρ_{N} (λ, k) by the sound and noise section determinator 4, the normalized autocorrelation function can also be calculated only for a band in which the SN ratio is higher than the predetermined threshold.

As mentioned above, according to this Embodiment 5, the noise suppression device is constructed in such a way as to use the second index calculated by using a signal component of the input signal in a frequency band in which the SN ratio is higher than the predetermined threshold. Therefore, the detection of spectral peaks and the calculation of the normalized autocorrelation function are performed only for a band in which the SN ratio is high, and therefore the accuracy of detection of spectral peaks and the accuracy of determination of a sound or noise section can be improved and higher-quality noise suppression can be performed.

### Embodiment 6

Because a noise suppression device according to this Embodiment 6 has the same structure as the noise suppression device, as shown in FIGS. 4 and 5, according to above-mentioned Embodiment 2 or the noise suppression device, as shown in FIG. 11, according to above-mentioned Embodiment 4 from a graphical viewpoint, the noise suppression device according to this embodiment will be explained by using FIGS. 1, 5, and 11. Although in above-mentioned Embodiments 2 to 5 the weighting on the SN ratio is performed in such a way that each of the probability density function controllers 7a and 7b enhances the spectral peaks, the weighting can be alternatively performed in such a way as to conversely enhance the valleys of the spectrum, that is, in such a way as to decrease the SN ratio at the valleys of the spectrum. As a method of detecting the valleys of the spectrum by the period component estimator 73, for example, the median value between the spectrum numbers of spectral peaks can be defined as a valley of the spectrum.

As mentioned above, according to this Embodiment 6, each of the probability density function controllers 7a and 7b has the period component estimator 73 that analyzes the harmonic structure of a sound in the input signal, and the weighted SN ratio calculator 75 is constructed in such a way as to use the result of the analysis by the period component estimator 73 as the second index to perform weighting on the SN ratio of another part of the power spectrum of the input signal. Therefore, the noise suppression device can make the periodic structure of a sound conspicuous and can perform higher-quality noise suppression.

### Embodiment 7

Because a noise suppression device according to this Embodiment 7 has the same structure as the noise suppression device, as shown in FIG. 1, according to above-mentioned Embodiment 1, the noise suppression device, as shown in FIG. 4, according to above-mentioned Embodiment 2, or the noise suppression device, as shown in FIG. 11, according to above-mentioned Embodiment 4 from a graphical viewpoint, the noise suppression device according to this embodiment will be explained by using FIGS. 1, 4, and 11. Although in above-mentioned Embodiments 1 to 6 each of the probability density function controllers 7, 7a, and 7b controls the probability density function for each spectral component, as to a high-frequency region, e.g., a high-frequency region of from 3 kHz to 4 kHz, each of the probability density function controllers can perform collective control on the basis of the average of the a posteriori SN ratios in the band, instead of the control using the a posteriori SN ratio for each spectral component.

As mentioned above, according to this Embodiment 7, because the control coefficient calculator 72 of each of the probability density function controllers 7, 7a, and 7b is constructed in such a way as to use the average SN ratio in a predetermined frequency band to control, the probability density function collectively for the frequency band, higher-quality noise suppression can be implemented and a reduction of the amount of information processed can also be accomplished.

### Embodiment 8

Because a noise suppression device according to this Embodiment 8 has the same structure as the noise suppression device, as shown in FIG. 1, according to above-mentioned Embodiment 1, the noise suppression device, as shown in FIG. 4, according to above-mentioned Embodiment 2, or the noise suppression device, as shown in FIG. 13, according to above-mentioned Embodiment 4 from a graphical viewpoint, the noise suppression device according to this embodiment will be explained by using FIGS. 1, 4, and 11. Although in above-mentioned Embodiments 1 to 7 each of the probability density function controllers 7, 7a, and 7b uses the a posteriori SN ratio of the input signal as the first index to control the probability density function, the present invention is not limited to this example, and each of the probability density function controllers can use another index showing whether the input signal appears to be a sound or noise. For example, one of indexes acquired by using known analyzing means, such as a variance of an input signal spectrum, spectrum entropy of the input signal spectrum, an autocorrelation function, and the number of zero crossings can be used singly, or a combination of two or more of the indexes can be used.

For example, in a case in which the variance of the input signal spectrum is used for the first index, because there is a high possibility that the input signal is a sound when the variance is large, each of the probability density function controllers 7, 7a, and 7b performs the control in such a way as to increase the first control coefficient ν (λ, k) while decreasing the second control coefficient μ (λ, k). When the variance is small, each of the probability density function controllers can perform the control in such a way as to conversely decrease the first control coefficient ν (λ, k) while increasing the second control coefficient μ (λ, k). Further, a function that brings the variance of the input signal spectrum, which is an index, into correspondence with the control coefficients can be determined experimentally by observing the state of the correspondence between the index and the control coefficients.

As mentioned above, according to this Embodiment 8, because the probability density function which is suited to the distribution state of a sound signal in a sound section and that in a noise section can be applied even when using an index other than the a posteriori SN ratio as the first index showing the state of the input signal, high-quality noise suppression which does not provide a feeling of unusual sound in the noise section and which provides a low distortion in the sound can be performed through the simple process. Further, the accuracy of the control of the probability density function can be improved by combining a plurality of indexes, and higher-quality noise suppression can be performed.

### Embodiment 9

Because a noise suppression device according to this Embodiment 9 has the same structure as the noise suppression device, as shown in FIGS. 4 and 5, according to above-mentioned Embodiment 2 or the noise suppression device, as shown in FIG. 11, according to above-mentioned Embodiment 4 from a graphical viewpoint, the noise suppression device according to this embodiment will be explained by using FIGS. 4 and 5. Although in above-mentioned Embodiment 2 the weighting factor calculator 74 calculates the harmonic structure weighting factor from he result of analysis of the harmonic structure of a sound, the weighted SN ratio calculator 75 performs weighting on the a posteriori SN ratio with the harmonic structure weighting factor Wₕ (λ, k), and the control coefficient calculator 72 controls the probability density function by using the a posteriori SN ratio on which the weighting is performed, the probability density function can be controlled directly from the result of analysis of the harmonic structure of a sound, for example.

Concretely, the periodicity information p(λ, k) outputted by the period component estimator 73 is inputted directly to the control coefficient calculator 72. When the periodicity information p (λ, k)=1, because there is a high possibility that the component lying within the band is a sound, the control coefficient calculator 72 performs control which increases the first control coefficient ν (λ, k) while decreasing the second control coefficient μ (λ, k). In contrast, when the periodicity information p (λ, k)=0, because there is a high possibility that the component lying within the band is noise, the control coefficient calculator performs control which decreases the first control coefficient ν (λ, k) while increasing the second control coefficient μ (λ, k). A function that brings the periodicity information which is a control factor into correspondence with the control coefficients can be determined experimentally by observing the state of the correspondence between the control factor and the control coefficients. In this structure, the weighting factor calculator 74 and the weighted SN ratio calculator 75, which are included in the probability density function controller 7a shown in FIG. 5, can be omitted.

As mentioned above, according to this Embodiment 9, each of the probability density function controllers 7a and 7b is constructed in such a way as to include the period component estimator 73 that analyzes the harmonic structure of a sound in the input signal, and the control coefficient calculator 72 that uses the result of analysis by the period component estimator 73 as the first index to control the probability density function. Therefore, because the probability density function which is suited to the distribution state of a sound signal in a sound section and that in a noise section can be applied, high-quality noise suppression which does not provide a feeling of unusual sound in the noise section and which provides a low distortion in the sound can be performed through the simple process. Further, because the processes including the calculation of the a posteriori SN ratio can be omitted, there is provided an advantage of reducing the amount of information processed.

Although in all the above-mentioned Embodiments 1 to 9 the explanation is made by using the maximum a posteriori method (Joint MAP method) as the noise suppression method, the embodiments can also be applied to another method (e.g., a minimum mean-square error short-time spectral amplitude estimator). Because the minimum mean-square error short-time spectral amplitude estimator is described in detail in, for example, “Speech Enhancement Using a Minimum Mean-Square Error Short-Time Spectral Amplitude Estimator” (Y. Ephraim, D. Malah, IEEE Trans. ASSP, vol. ASSP-32, No. 6 Dec. 1984), the explanation of the method will be omitted hereafter.

Further, although in all the above-mentioned Embodiments 1 to 9 the case of a narrow band phone (0 to 4000 Hz) is explained, the present invention is not limited to narrow band telephone voices. For example, the present invention can also be applied to acoustic signals, such as wide band telephone voices, such, as telephone voices lying within a range of from 0 to 8000 Hz, and musical pieces.

Further, although in all the above-mentioned Embodiments 1 to 9 the output signal on which the noise suppression is performed is sent out in a form of digital data to one of various sound acoustic processors, such as a sound coding device, a voice recognition device, a sound storage device, and a handsfree call device. The noise suppression device according to any one of Embodiments 1 to 9 of the present invention can be implemented singly or via a DSP (digital signal processor) together with one of the above-mentioned other devices, or can be implemented by carrying out the processing as a software program. The program can be stored in a storage device of a computer which executes the software program, or can have a form in which the program is distributed via a storage medium such as a CD-ROM. Further, the program can be provided via a network. In addition to sending out the output signal to one of various sound acoustic processors, the output signal can be amplified by an amplifying device after D/A (digital to analog) converted, and can be outputted as a sound signal directly from a speaker or the like.

While the invention has been described in its preferred embodiments, it is to be understood that, in addition to he above-mentioned embodiments, an arbitrary combination of two or more of the embodiments can be made, various changes can be made in an arbitrary component according to any one of the embodiments, and an arbitrary component according to any one of the embodiments can be omitted within the scope of: the invention.

### INDUSTRIAL APPLICABILITY

As mentioned above, because the noise suppression device in accordance with the present invention can per form; high-quality noise suppression, the noise suppression device is suitable for an improvement in the sound quality of a voice communication system, such as car navigation, a mobile phone, or an interphone, a handsfree call system, a TV conference system, a monitoring system, and so on, into each of which voice communications, a voice storage, and a voice recognition system are introduced, and an improvement in the recognition rate of the voice recognition system.

### EXPLANATIONS OF REFERENCE NUMERALS

1 input terminal,
2 Fourier transformer,
3 power spectrum calculator,
4 voice and noise section determinator,
5 noise spectrum estimator,
6 SN ratio calculator,
7, 7a, and 7b probability density function control,
8 suppression amount calculator,
9 spectrum suppressor,
10 inverse Fourier transformer,
11 output terminal,
71 second SN ratio calculator,
72 control coefficient calculator,
73 period component estimator,
74 weighting factor calculator,
75 weighted SN ratio calculator

1. A noise suppression device that converts an input signal in time domain into a power spectrum which is a signal in frequency domain, calculates a suppression amount for noise suppression by using said power spectrum and an estimated noise spectrum estimated separately from said input signal, performs amplitude suppression on said power spectrum according to said suppression amount, and converts said power spectrum on which the amplitude suppression is performed into a signal in time domain to acquire a noise-suppressed signal, wherein said noise suppression device comprises a probability density function controller that analyzes said input signal to calculate a first index showing whether said input signal appears to be a voice or noise, and that controls a probability density function that defines a distribution state of a sound on a basis of said first index, and calculates said suppression amount by using said probability density function in addition to said power spectrum and said noise estimated spectrum.

2. The noise suppression device according to claim 1, wherein said probability density function controller includes an SN ratio calculator that estimates an SN ratio for each frequency of said input signal, and a control coefficient calculator that controls said probability density function by using the SN ratio estimated by said SN ratio calculator as said first index.

3. The noise suppression device according to claim 2, wherein said probability density function controller includes a weighted SN ratio calculator that performs weighting on said SN ratio estimated for each frequency on a basis of a second index showing whether said input signal appears to be a voice or noise, and said control coefficient calculator controls said probability density function by using the weighted SN ratio calculated by said weighted SN ratio calculator as said first index.

4. The noise suppression device according to claim 3, wherein said second index is at least one of an SN ratio which is calculated by using the power spectrum and the estimated noise spectrum of said input signal, a result of determination, of a sound section or a noise section which is performed on a basis of the power spectrum of said input signal, and an analysis result of analyzing a harmonic structure of a sound in said input signal.

5. The noise suppression device according to claim 3, wherein said probability density function controller has a weighting factor calculator that controls Intensify of weighting by said weighted SN ratio calculator according to a state of said input signal.

6. The noise suppression device according to claim 3, wherein said probability density function controller includes a weighting factor calculator that controls intensity of weighting by said weighted SN ratio calculator according to a frequency.

7. The noise suppression device according to claim 1, wherein said probability density function controller includes a period component estimator that analyzes a harmonic structure of a sound in said input signal, and a control coefficient calculator that controls said probability density function by using a result of the analysis by said period component estimator as said first index.

8. The noise suppression device according to claim 4, wherein said second index is calculated by using a signal, component, which is included in said input; signal, in a frequency band in which the SN ratio is higher than a predetermined threshold.

9. The noise suppression device according to claim 3, wherein said probability density function controller includes a period component estimator that analyzes a harmonic structure of a sound in said input signal, and said weighted SN ratio calculator uses a result of the analysis by said period component estimator as said second index to perform at least one of weighting which is done in such a way that an SN ratio of a peak of the power spectrum of said input signal is increased, and weighting which is done in such a way that an SN ratio of a valley of said power spectrum is decreased.

10. The noise suppression device according to claim 2, wherein said control coefficient calculator uses an average SN ratio in a predetermined frequency band to control said probability density function collectively for said frequency band.
